(19) United States
(12) Patent Application Publication
(10) Pub. No.: US 2010/0033325 A1
(43) Pub. Date: Feb. 11, 2010

(54) TOOL CONTAINER WITH AN ALARM SYSTEM

(75) Inventors: Gil VILKOMIRSKI, Petach Tiqwa (IL); Iftach Galler, Kfar-Hess (IL)

Correspondence Address: PILLSBURY WINTHROP SHAW PITTMAN, LLP, P.O. BOX 10500, MCLEAN, VA, 22102, US

(73) Assignee: The Stanley Works Israel Ltd., Rosh Ha'Ayin (IL)

(21) Appl. No.: 12/537,631

(22) Filed: Aug. 7, 2009

Related U.S. Application Data
(60) Provisional application No. 61/087,061, filed on Aug. 7, 2008.

(51) Int. Cl. G08B 21/00

(52) U.S. Cl. 340/540

(57) ABSTRACT

A tool container and alarm system includes a tool container and an alarm system. The tool container includes a container and a cover. The alarm system is generally carried by the container and has an activated state and a deactivated state. The alarm system, when in the activated state, is capable of outputting an alarm indication in response to a condition of the tool container. The alarm system includes a detector, a controller, a signaling device and a power supply. The detector is configured to detect the condition of the tool container. The controller is configured to receive an input signal from the detector based on the detected condition of the tool container. The signaling device is operatively connected to the controller and is configured to generate the alarm indication in response to receiving an output signal from the controller.

This application claims priority and benefit under 35 U.S.C. §119(e) to U.S. Provisional Patent Application No. 61/087,061, entitled “Tool Container With An Alarm System”, filed on Aug. 7, 2008. The content of that application is incorporated herein in its entirety by reference.

### BACKGROUND OF THE INVENTION

### Field of the Invention

The present invention relates to a tool container, and, more particularly to a tool container which carries an alarm system.

Numerous tool container assemblies are known in the art. These tool container assemblies can be easily transported from one place to another, and store tools that are needed for accomplishing a task. However, theft of tools from the container assemblies is often a problem.

### SUMMARY

One aspect of the invention relates to a tool container and alarm system. The tool container and alarm system includes a tool container and an alarm system. The tool container includes a container and a cover. The container includes a storage space and defines an upwardly facing opening into the storage space. The cover is movable between a closed position wherein the cover substantially covers the upwardly facing opening and an open position wherein the upwardly facing opening is substantially exposed. The alarm system is generally carried by the container and includes an activated state and a deactivated state. The alarm system, when in the activated state, is capable of outputting an alarm indication in response to a condition of the tool container. The alarm system includes a detector, a controller, a signaling device, and a power supply. The detector is configured to detect the condition of the tool container. The controller is configured to receive an input signal from the detector based on the detected condition of the tool container. The signaling device is operatively connected to the controller and is configured to generate the alarm indication in response to receiving an output signal from the controller. The output signal from the controller is generated in response to the input signal from the detector. The power supply is configured for powering the detector and the signaling device.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a perspective view of a tool container and alarm system in accordance with one embodiment;

FIG. 2 is a perspective view of the tool container and alarm system, wherein an alarm cover is removed to expose the alarm system in accordance with one embodiment;

FIG. 3 is a detailed view of the alarm system in accordance with one embodiment;

FIG. 4 is a side view of the tool container and alarm system in accordance with one embodiment;

FIG. 5 is a side schematic view of the tool container and alarm system, wherein the alarm system, when in an activated state, is capable of outputting an alarm indication in response to a condition of the tool container in accordance with one embodiment;

FIG. 6 is a side schematic view of the tool container and alarm system, wherein a RF receiver (responsive to the hand-held remote transmitter) is connected to a controller, and the controller is also connected to a power supply, a lock, a signaling device, and a detector in accordance with one embodiment;

FIG. 7 is a schematic view of a user interface panel attached to a cover of the tool container, wherein the user interface panel is operatively connected to a controller of the alarm system in accordance with one embodiment

FIG. 8 is a front view of a hand-held remote transmitter operatively connected to the controller of the alarm system in accordance with one embodiment; and

FIG. 9 is a flow diagram illustrating operating procedures performed by the controller of the alarm system in accordance with one embodiment.

### DETAILED DESCRIPTION OF THE INVENTION

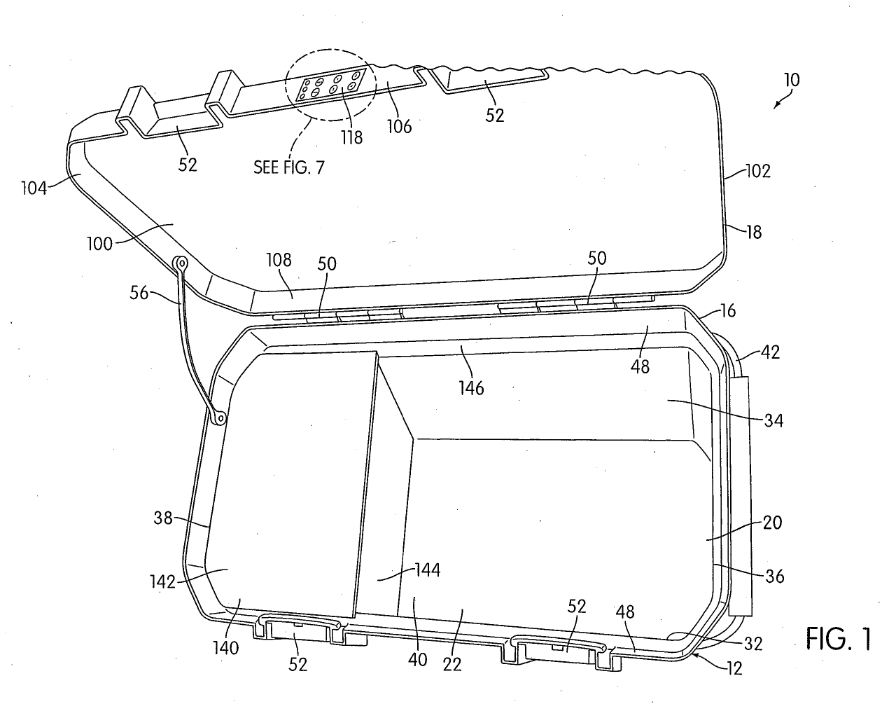

FIGS. 1, 2 and 3 show a tool container and alarm system 10 in accordance with an embodiment of the present invention. The tool container and alarm system 10 includes a tool container 12 and an alarm system 14. The tool container 12 includes a container 16 and a cover 18. The container 16 includes a storage space 20 and defines an upwardly facing opening 22 into the storage space 20. The cover 18 is movable between a closed position wherein the cover 18 substantially covers the upwardly facing opening 22 and an open position wherein the upwardly facing opening 22 is substantially exposed. The alarm system 14 is generally carried by the tool container 12 and has an activated state and a deactivated state. The alarm system 14, when in the activated state, is capable of outputting an alarm indication in response to a condition of the tool container 12. The alarm system 14 includes a detector 24, a controller 26, a signaling device 28, and a power supply 30. The detector 24 is configured to detect the condition of the tool container 12. The controller 26 is configured to receive an input signal from the detector 24 based on the detected condition of the tool container 12. The signaling device 28 is operatively connected to the controller 26 and is configured to generate the alarm indication in response to receiving an output signal from the controller 26. The output signal from the controller 26 is generated in response to the input signal from the detector 24. The power supply 30 is configured for powering the detector 24 and the signaling device 28. The power supply 30 provides power (directly or indirectly) to any of these components that may require power source to be operated. The connections between the detector 24, the controller 26, and the signaling device 28 may be hardwired, wireless, or any combination thereof.

In one embodiment, the container 16 of the tool container 12 includes a pair of side walls 32 and 34, a front wall 36, and a rear wall 38, and a bottom wall 40. The front wall 36, the rear wall 38 and the opposed side walls 32 and 34 are constructed and arranged to generally extend vertically upwardly from the bottom wall 40. The front wall 36 and the rear wall 38 are joined to each other by the opposed side walls 32 and 34 to form the aforementioned storage space 20 therewithin with the upwardly facing opening 22 in the container 16. In one embodiment, the base container 16 is formed from a suitable molded plastic material.

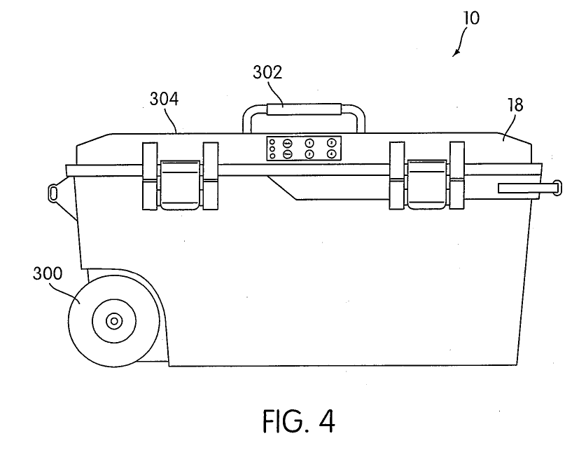

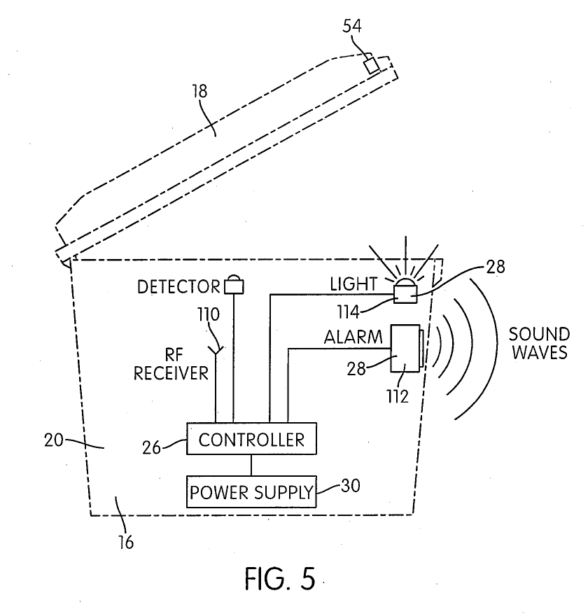

The cover 18 generally includes a top wall 100, a front wall 102, a rear wall 104, and opposed side walls 106 and 108. The front wall 102, the rear wall 104 and the opposed side walls 106 and 108 are constructed and arranged to generally extend vertically downwardly from the top wall 100 (when the tool container 12 is resting on the ground as shown in FIG. 4). In one embodiment, the cover 18 may be pivotally connected to the side wall 34 of the container 16 using hinge members 50. The cover 18 may be secured in the closed position, by at least one latch 52 (two are shown). In one embodiment, a lock 54 (as shown in FIG. 5) may be provided to lock the cover 18 in the closed position. In some embodiments, the lock 54 may be a key lock or a combination lock. In another embodiment, the lock 54 is an electrically operated lock that is in communication (e.g., hardwired or wireless) with the controller 26. By releasing the latch(es) 52 and unlocking the lock 54, the cover 18 may be pivoted about the hinge members 50 to the open position to access the tools or articles stored in the storage space 20 of the container 16 of the tool container 12. In one embodiment, the cover 18 may be coupled to the front wall 36 and/or the rear wall 38 of the container 16 using at least one linkage member 56 (one is shown). The linkage members 56 are constructed and arranged to support the cover 18 when the cover 18 is in the open position. The linkage members 56 may also be configured to act as a stop to limit the movement of the cover 18 beyond a maximum open position of the cover 18. In one embodiment, the linkage members 56 are made from a flexible material (such as a chain, wire, rope or string, for example) so that the linkage members 18 are in a slack configuration, when the cover 18 is in the closed position. In another embodiment, the linkage members 18 may take the form of a two bar linkage, pin and slot arrangement, or other type linkage known in the art.

In one embodiment, the tool container 12 includes an extendable handle 42 and rollers 300 (as shown in FIG. 4). The tool container 12 may include an extendable handle and rollers as described in U.S. Publication Application Ser. No. 12/165,715, filed on Jul. 1, 2008, hereby incorporated by reference in its entirety. Any of the other features/aspects of U.S. Publication Application Ser. No. 12/165,715 may also be used in the present invention.

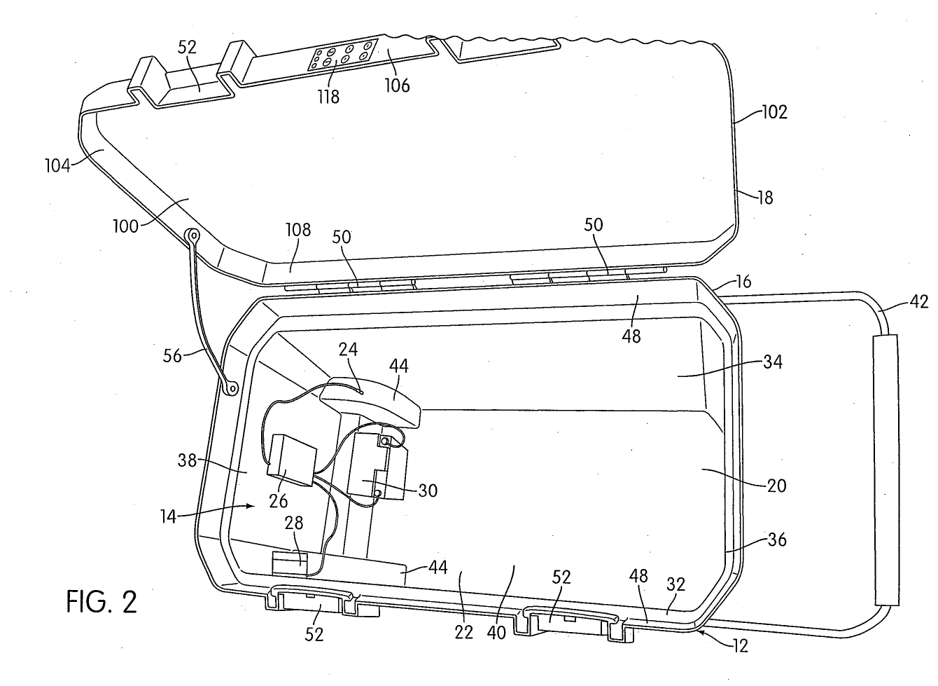

The extendable handle 42 is operatively connected to the container 16 to facilitate tilted rolling transport of the tool container and alarm system 10. The container 16 includes a pair of handle receiving portions formed near a top edge 48 along the opposing side walls 32 and 34. The handle receiving portions are constructed and arranged to receive the handle 42 therewithin, when the handle 42 is in a retracted position. In one embodiment, the handle receiving portions are hollow structures that are configured to telescopically receive legs of the handle 42 to enable extension and retraction respectively. As shown in FIG. 2, the extendable handle 42 is shown in an extended position to facilitate tilted rolling transport of the tool container and alarm system 10.

The rollers 300 are connected with the container 16 to enable transport of the tool container 12. In one embodiment, the rollers 300 may be in the form of wheels and may facilitate rolling transport of the tool container 12. In one embodiment, the rollers 300 are mounted in a recess 44 formed in the base container 12 so that the tool container 12 may be tilted and pulled or pushed along a horizontal surface (e.g., ground surface) by the user holding the handle 42. The rollers 300, in one embodiment, may optionally be locked against rolling motion by roller lock members that are operatively connected to the rollers 300 to provide a stationary configuration. Preferably the each wheel is a molded structure reinforced by a plurality of wheel ribs (not shown) and each wheel is mounted on an end of an elongated axle by two hubs or other appropriate structure. The axle may be an elongated cylindrical steel shaft that is snap fit into rotational engagement with a receiving structure of the container 16. Alternatively, the axle can be mounted to the tool container 12 through a pair of axially aligned through-holes formed in the rear wall 38 of the container 16.

In one embodiment, the tool container 12 may include a carrying handle 302. The carrying handle 302 is constructed and arranged to be attached to a top surface 304 of the cover 18 as shown in FIG. 4. In embodiments where a carrying handle 302 is used, the handle 42 and rollers may optionally be eliminated (and vice versa).

In one embodiment, as shown in FIG. 1, the tool container and alarm system 10 includes a cover 140 that is constructed and arranged to cover the alarm system 14. The cover 140 is constructed and arranged to protect the alarm system 14 by providing a tear and/or penetration resistant enclosure in which the alarm system 14 is stored. In one embodiment, the cover 140 is constructed and arranged to be connected to and removed from the tool container 12 (e.g., via fasteners). In one embodiment, the cover 140 includes a first portion 142 and a second portion 144 that are hingeably connected to each other. In one embodiment, the first portion 142 is constructed and arranged to rest on protrusions (not shown) or a lip 146 which form support surfaces that are integrally formed in the walls of the tool container 12. The second portion 144 is constructed and arranged to fit between the opposing side walls 32 and 34 of the tool container 12. In one embodiment, when the cover 140 is placed in a covering relation with the alarm system 14, the first portion 142 generally lies parallel to the bottom wall 40 of the tool container 12 and the second portion 144 generally lies parallel to the front wall 36 and/or the rear wall 38 of the tool container 12.

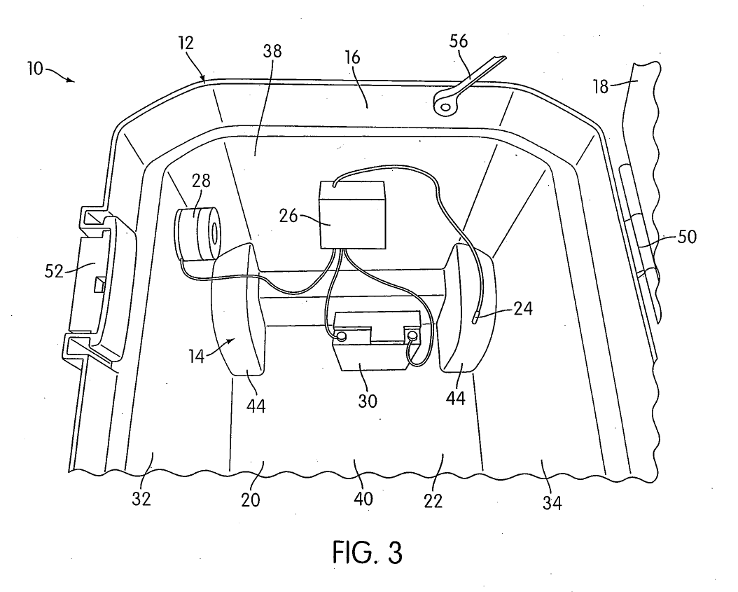

Referring now to FIGS. 3, 5 and 6, the alarm system 14 is disposed in the container 16. In another embodiment, the alarm system 14 may be disposed in or carried by the cover 18. The alarm system 14, when in the activated state, is capable of outputting the alarm indication in response to the condition of the tool container 12. The alarm system 14, when in the deactivated state, is disabled from outputting the alarm indication in response to the condition of the tool container 12. Such disablement is controlled by the controller 26. The condition of the container that will cause the alarm system 14 to output an alarm condition may vary. In addition, different types of detectors can be used. For example, in one embodiment, the condition of the tool container 12 comprises opening of the cover 18 from the closed position. In another embodiment, the condition of the tool container 12 comprises a movement of the tool container 12 (e.g., as detected by a motion detector 24). In another embodiment, both or either of such conditions is used.

As noted above, the detector 24 of the alarm system 14 is configured to detect the condition of the tool container 12. In one embodiment, the detector 24 is a motion detector. In another embodiment, the detector 24 is a switch or an opening detector that detects an opening of the cover 18. In yet another embodiment, the detector 24 includes two or more detectors. In such embodiment, the at least two detectors can include both a motion detector and a switch or an opening detector that detects an opening of the cover 18.

The motion detector (if provided) is configured to detect a movement of the tool container 12. The motion detector may include a tilt detector and/or an acceleration detector. When the alarm system 14 is in the activated state, and an acceleration detector is used, the acceleration detector is configured to detect the acceleration of the tool container 12 and, thus, detect the movement of the tool container 12. In one embodiment, for example, the acceleration of the tool container 12 is detected in three different axes (e.g., X, Y and Z axes) using one or more acceleration sensors. However, only a single axis (or degree of freedom) of detection can be used.

When a tilt detector or sensor is used, and when the alarm system 14 is in the activated state, the tilt detector is configured to detect an inclination or a tilt (e.g., angle) of the tool container 12 and, thus, detect the movement of the tool container 12.

The switch or opening detector, if used, is configured to detect an opening of the cover 18. The opening detector may include a light detector. The switch may include an electromechanical switch (e.g., microswitch), or a magnetic switch.

When the alarm system 14 is in the activated state, and the switch detector is used, the electromechanical switch (e.g., microswitch), the magnetic switch, or proximity detector can be configured to provide an input signal to the controller 26. The input signal is provided to the controller 26 when the switch is activated representing the opening or movement of the cover 18. In such arrangement, some interengagement (e.g., mechanical, electric, magnetic, etc.) between the container 16 and the cover 18 is disengaged, and the detector 24 outputs a signal that is received as the input signal to the controller 26. For example, when closed, the cover 18 may engage a contact portion of the detector 24, and the opening in the cover 18 will disengage the contact to trigger the detector 24, or the detector 24 may magnetically detect the proximity of the cover 18 when the cover 18 is closed and generate a signal when open. In another embodiment, the mechanical contact or magnet elements are positioned such that when the cover 18 reaches a predetermined angle (i.e., the cover 18 is open to a predetermined extent), the mechanical contact or proximity detector is actuated, and the detector 24 then generates the signal. Numerous other arrangements can alternatively be provided.

In one embodiment, a light detector is used to provide the input signal to the controller 26 when the light detector is activated (e.g., when being exposed to ambient light) representing the opening or movement of the cover 18. In such embodiment, a photo-sensor operates as a detector and detects the ambient light entering the tool container 12, when the cover 18 of the tool container 12 is opened, and provides the input signal to the controller 26.

As noted above, the controller 26 is configured to receive the input signal from the detector 24 based on the detected condition of the tool container 12. In the illustrated embodiment, as shown in FIGS. 2 and 3, the controller 26 is attached to the rear wall 38 of the tool container 12. However, it is contemplated that the controller 26 may be located anywhere within or on the tool container 12. In one embodiment, the controller 26 is in the form of a microcontroller. Just for example, the microcontroller may include a Microchip PIC18 series architecture. In one embodiment, the controller 26 is configured to process the input signals from the detector 24 based on the condition of the tool container 12 and to generate the output signal to the signaling device 28. In one embodiment, the controller 26 can control the operation of a wireless receiver 110 as will be described later.

In the illustrated embodiment, as shown in FIGS. 2 and 3, the signaling device 28 is attached to the side wall 32 of the tool container 12. However, it is contemplated that the signaling device 28 may be located anywhere in or on the tool container 12. The signaling device 28 includes a speaker 112 (or other sound producing device) and/or one or more lights 114. The speaker 112 or other sound producing device, if provided, is constructed and arranged to generate an audio alarm indication in response to the condition of the tool container 12 detected by the detector 24. The one or more lights 114, if provided, are constructed and arranged to generate a visual alarm indication in response to the condition of the tool container 12 detected by the detector 24.

In one embodiment, the alarm indication of the signaling device 28 is the audio alarm indication that is generated by the speaker 112. Just for example, the signaling device 28 may be a siren with five volts buzzer. The audio alarm indication may include, but not limited, to a tone, a buzz, a beep, a sound (e.g., a horn or a chime), and/or a prerecorded voice message. In one embodiment, the audio alarm indication may include tones with changing frequency or volume. In another embodiment, the audio alarm indication may include customer configurable tones and alarms.

In one embodiment, the alarm indication of the signaling device 28 is a visual alarm indication that is generated by one or more lights 114. In one embodiment, for example, in the case of a plurality of different color lights, each of the plurality of lights emits different visual alarm indications (e.g., different color alarms) corresponding to the different conditions of the tool container 12. In one embodiment, the lights may include lamps, light emitting diodes and/or liquid crystal displays. In another embodiment, the visual alarm indication may be generated by, for example, continuous, flashing or strobe lights.

As noted above, the power supply 30 is configured for powering the detector 24 and the signaling device 28. The power supply 30 can be located, for example, in the aforementioned storage space 20 of the tool container 12. In the illustrated embodiment, as shown in FIGS. 2 and 3, the power supply 30 is placed on the bottom wall 40 of the tool container 12. However, it is contemplated that the power supply 30 may be located anywhere within or on the tool container 12. In one embodiment, the power supply 30 is a battery or a plurality of batteries. In one embodiment, the tool container and alarm system 10 may include hardware that is configured to measure the voltage of the power supply 30 (e.g., battery). In such embodiment, the tool container and alarm system 10 is configured to generate a warning indication when a low voltage condition of the power supply 30 is detected.

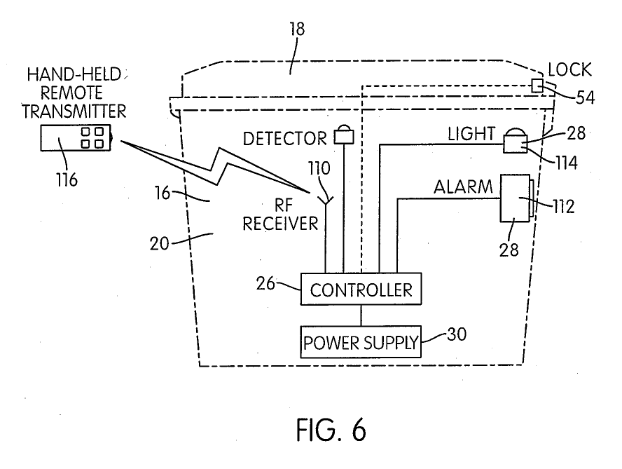

In one embodiment, the lock 54 of the tool container 12 can be operatively connected to the controller 26. In such embodiment, the lock 54 is constructed and arranged to lock the cover 18 in the closed position (as shown in FIG. 6). In one embodiment, the lock 54 includes an electromagnetic lock. In such embodiment, the electromagnetic lock is constructed and arranged to move a metal bar to lock and unlock the cover 18. In another embodiment, the lock 54 includes an electrically operated lock. In such embodiment, the lock 54 includes a solenoid. In one embodiment, the solenoid may be a two-directional solenoid. In one embodiment, a solenoid driver is used to ensure highly reliable solenoid control for the locking and unlocking the cover 18. In such embodiment, the solenoid driver may include two N-channel MOSFETs.

In one embodiment, the signaling device 28 and/or the detector 24 is deactivated by the controller 26 when the lock 54 is moved to the unlocked condition. The lock 54 can be controlled by the controller 26.

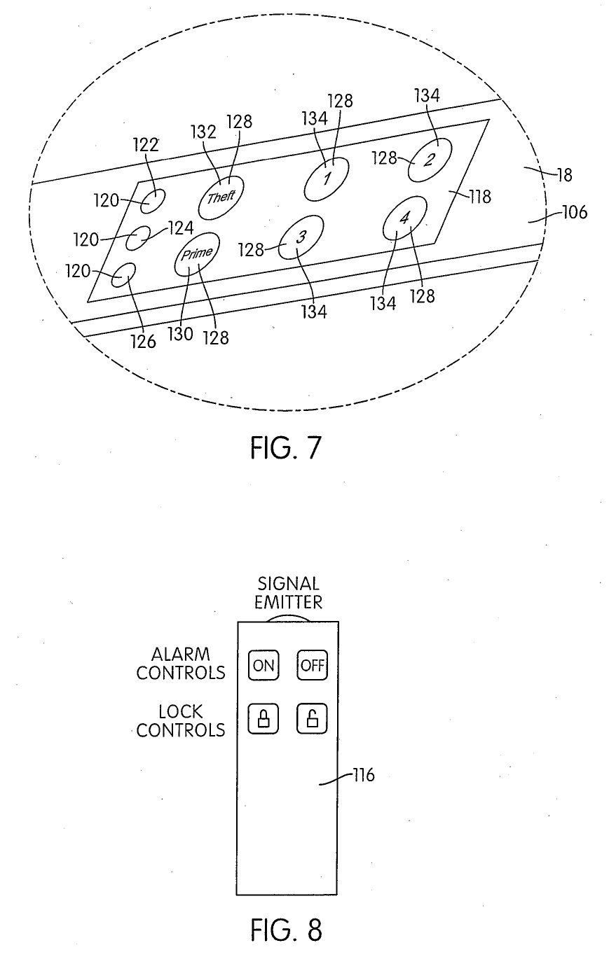

The tool container and alarm system 10 may include a plurality of operating modes. In one embodiment, a user selects one of the plurality of operating modes of the tool container and alarm system 10 via an user interface panel 118 (as shown in FIG. 7) or a wireless device 116 (as shown in FIG. 8). The plurality of operating modes may include an idle mode, a theft mode, a lock mode, a prime mode or any combination thereof. The idle mode is an operating mode where the alarm system 14 is in the deactivated state. The theft mode, the lock mode, and the prime mode are operating modes where the alarm system 14 is in an activated state. Any of these modes may be selected via the interface panel 118 (e.g., via entry of a passcode or PIN code or otherwise)

The idle mode is an initial or a default operating mode of the tool container and alarm system 10. The idle mode is referred to as an operating mode in which the alarm system 14 is in the deactivated state, and the lock 54 of the tool container 12 is in the unlocked condition. Optionally, the deactivated state may exist only when the lock 54 is unlocked. In another embodiment, the alarm system 14 may optionally be deactivated (e.g., by entry of a passcode or otherwise) whether the lock 54 is locked or unlocked.

The theft mode is referred to as an operating mode in which the alarm system 14 is in activated state, and the condition of the tool container 12 includes detecting the movement of the tool container 12. In one embodiment, in the theft mode, the lock 54 of the tool container 12 is in an unlocked condition. In another embodiment, the alarm system 14 may optionally be activated (e.g., by entry of a passcode or otherwise) whether the lock 54 is locked or unlocked. In one embodiment, for example, when the tool container 12 is in the theft mode and is moved around at all, or optionally for at least a certain amount of time, the signaling device 28 generates the alarm indication in response to the input signal from the motion detector.

The lock mode is referred to as an operating mode in which the alarm system 14 is in an activated state, and the condition of the tool container 12 includes detecting the movement of the cover 18 away from the closed position. In the lock mode, the lock 54 of the tool container 12 is in a locked condition. In one embodiment, for example, when the tool container 12 is in the lock mode and the cover 18 of the tool container 24 is forced opened from the closed position, the signaling device 28 generates the alarm indication in response to the input signal from the switch or the opening detector that detects the opening or the movement of the cover 18.

The prime mode is referred to as an operating mode in which the alarm system 14 is in an activated state, and the condition of the tool container 12 includes detecting the movement of the cover 18 away from the closed position and/or detecting the movement of the tool container 12. In the prime mode, the lock 54 of the tool container 12 is in the locked condition. In another embodiment, the alarm system 14 may optionally be activated (e.g., by entry of a passcode or PIN code or otherwise) whether the lock 54 is locked or unlocked. In one embodiment, for example, when the tool container 12 is in the prime mode, and the cover 18 of the tool container 12 is forced opened and/or the tool container 12 is moved around at all, or optionally for at least the certain amount of time, the signaling device 28 generates the alarm indication in response to the input signal from the switch or opening detector that detects the opening of the cover 18 and/or the input signal from the motion detector 24.

In one embodiment, the tool container and alarm system 10 may be moved to the idle operating mode (i.e., the alarm system 14 is in the deactivated state) either using the user interface panel 118 or the wireless device 116.

In one embodiment, as shown in FIG. 7, the tool container and alarm system 10 includes the user interface panel 118 mounted on the cover 18. In one embodiment, the user interface panel 118 is located on the side wall 106 of the cover 18. The user interface panel 118 is operatively connected to the controller 26 to change the alarm system 14 between the activated state and deactivated state, and can be used to change the mode of operation. The user interface panel 118 includes a plurality of illuminators 120 configured to provide an indication of the condition of the tool container 12. In one embodiment, the plurality of illuminators 120 may include three illuminators, for example, each having a different color. In one embodiment, the plurality of illuminators 120 may include a first illuminator 122, a second illuminator 124, and a third illuminator 126. For example, the first illuminator 122 may include a red LED, a second illuminator 124 may include a yellow LED, and a third illuminator 126 may include a green LED.

The user interface panel 118 comprises a plurality of user-activated keys 128 configured to select the operating modes of the tool container and alarm system 10 (e.g., the condition of the tool container 12). In one embodiment, the plurality of user-activated keys 128 may include a user-activated key 130 for the prime mode and a user-activated key 132 for the theft mode. In one embodiment, the plurality of user-activated keys 128 may further include a plurality of numeric user-activated keys 134 that may be actuated to select the lock mode. In one embodiment, the keys may be set or coded to work with a certain combination of inputs (a PIN code) to set the mode of operation or to change the state between the activated and deactivated states, or to change modes. The passcode or combination code may optionally be changeable by the user.

In one embodiment, as noted above, the initial or default mode is the idle mode. The user may actuate the user-activated keys 128 to select other operating modes, for example, the theft mode, the prime mode, and the lock mode. In one embodiment, when the user actuates the user-activated key 130 for the prime mode, the first illuminator 122 (e.g., red LED) and the second illuminator 124 (e.g., yellow LED) illuminate for a certain amount of time to indicate that the primed mode is selected. In one embodiment, the certain amount of time is two seconds. In one embodiment, when the user actuates the user-activated key 132 for the theft mode, the first illuminator 122 (e.g., red LED) illuminates for a certain amount of time to indicate that the theft mode is selected. In one embodiment, the user actuates the numeric user-activated key 134 to move the lock to a locked position and to select the lock mode. In one embodiment, when the user actuates the numeric user-activated key 134, the second illuminator 124 (e.g., yellow LED) illuminates for a certain amount of time to indicate that the lock mode is selected.

In one embodiment, in order to return to the idle mode (e.g., from any of the other operating modes, that is the theft mode, the prime mode, and the lock mode), the user first actuates either the user-activated key 132 (e.g., for the theft mode) or the user-activated key 130 (e.g., for the prime mode), and the user then enters a PIN code using the plurality of numeric user-activated keys 134. The controller 26 verifies the entered PIN code. When the correct PIN code is entered, the lock is moved into the unlocked position, the tool container and alarm system 10 is returned to the idle mode in which the alarm is in the deactivated state. In one embodiment, when the user enters the correct PIN code, the third illuminator 126 (e.g., green LED) illuminates for a certain amount of time to indicate that the tool container and alarm system 10 has returned to the idle mode. When an incorrect PIN code is entered, the first illuminator 122 (e.g., red LED) illuminates for a certain amount of time to indicate that an invalid PIN code was entered. In one embodiment, when the incorrect PIN code is entered for a predetermined number of consecutive times, an alarm indication (audio or video) will be presented.

Alternatively, in one embodiment, presenting a valid RFID tag or transponder, or actuating a user-actuated key on the hand-held remote transmitter 116 returns the tool container and alarm system 10 to the idle mode (i.e., the alarm system 14 is in the deactivated state).

In one embodiment, the tool container and alarm system 10 includes the wireless device 116 operatively communicated with the controller 26 and configured to generate signals to change the alarm system 14 between the activated state and the deactivated state, and/or to change the mode of operation. The controller 26 includes the receiver 110 (such as an RF or IF receiver) wirelessly communicated with the wireless device 116. The receiver 110 is configured to receive the signals from the wireless device 116. In one embodiment, the wireless device 116 is a radio-frequency identification tag or transponder. In such embodiment, the radio-frequency identification tag or transponder may include an EM4102 ASK 125 Khz compatible card. In another embodiment, as shown in FIGS. 6 and 8, the wireless device 116 is a hand-held remote transmitter. In such embodiment, the transmitter 116 includes a RF transmitter.

In one embodiment, the wireless device 116 may include all of the same inputs as the interface panel 118 to enable full remote control of the device 10.

In illustrated embodiment, the hand-held remote transmitter includes user-actuated keys for locking and unlocking the cover 18 of the tool container 12, as well as activating and deactivating the alarm system 14. In another embodiment, the hand-held remote transmitter may include the same user-actuated keys (e.g., described with respect to FIG. 7) that are located on the user interface panel 118.

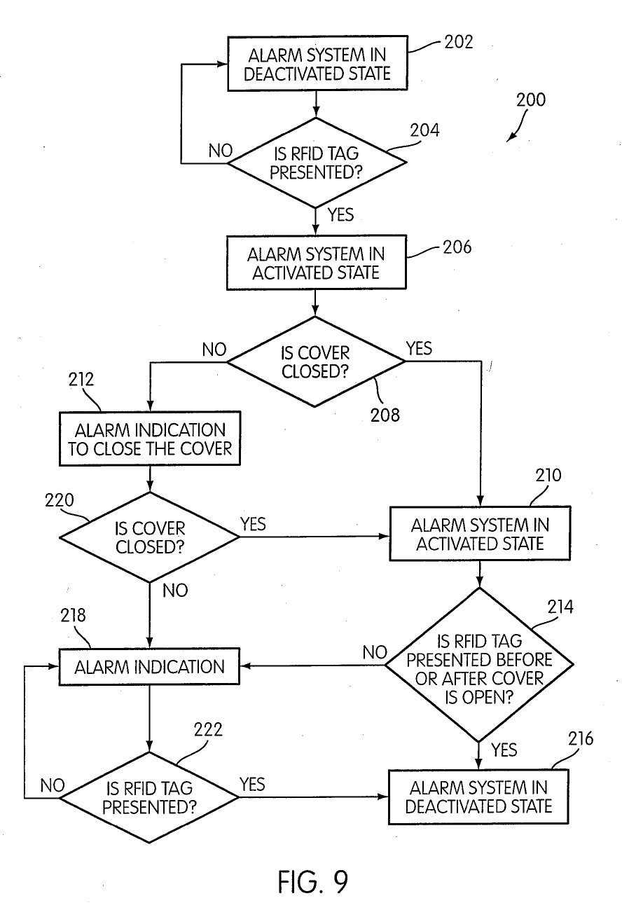

In one embodiment, a method 200 for operating the alarm system 14 is performed by the controller 26. The method 200 is shown in FIG. 9. The method 200 starts at procedure 202 in which the alarm system 14 is in a deactivated state. As noted earlier, the alarm system 14, when in the deactivated state, is disabled from outputting the alarm indication in response to the condition of the tool container 12. The controller 26 controls the method 200 by proceeding to procedure 204. At procedure 204, the controller 26 determines whether a RFID is presented. If the controller 26 determines that the RFID is presented, the controller 26 proceeds to procedure 206 in which the alarm system 14 is changed to the activated state. As noted earlier, the alarm system 14, when in the activated state, is capable of outputting the alarm indication in response to the condition of the tool container 12. If the controller 26 determines the RFID is not presented, the method 200 returns to procedure 202, where the alarm system 14 remains in the deactivated state.

After changing the alarm system 14 to the activated state (e.g., at procedure 206), the method 200 proceeds to procedure 208 in which the controller 26 determines whether the cover 18 is closed. If the controller 26 determines that the cover 18 is closed, the controller 26 proceeds to procedure 210 in which the alarm system 14 remains in the activated state. The method 200 will remain at step 210 until either an RFID is presented or some other condition is met (e.g., the cover is open). If an RFID tag is presented to the tool container, then at procedure 214 the controller 26 will recognize the RFID tag and the controller 26 proceeds to procedure 216 in which the alarm system 14 is changed to the deactivated state. If the controller 26 determines at procedure 214 that the cover 18 has been open but the RFID tag has not been presented, the controller 26 proceeds to procedure 218 in which the alarm system 14 is in the activated state and the configured to generate the alarm signal (e.g., audio or visual indication) in response to the condition of the tool container 12. The alarm will continue at procedure 218 until the RFID tag is presented at procedure 222.

If, at procedure 208, the controller 26 determines the cover 18 is not closed, the method 200 proceeds to procedure 212, where a preliminary audio and/or video indication is presented for at least a certain amount of time. Such audio and/or video indication is configured to provide a prompt to the user to close the cover 18. The method 200 then proceeds to procedure 220 in which the controller 26 determines whether the cover 18 is closed. If the controller 26 determines that the cover 18 is closed, the controller 26 proceeds to procedure 210 in which the alarm system 14 remains in the activated state as described above. If the controller 26 determines the cover 18 is not closed within a certain amount of time, the method 200 proceeds to procedure 218 which the alarm system 14 is in the activated state and the configured to generate the alarm signal (e.g., audio or visual indication) in response to the condition of the tool container 12. In one embodiment, the alarm indication at procedure 218 is different than that at procedure 212 (e.g., it can be a higher volume (louder) audio output).

After generating the alarm signal (e.g., audio or visual indication) in response to the condition of the tool container 12 at procedure 218, the method 200 proceeds to procedure 222. At procedure 222, the controller 26 determines whether a RFID is presented. If the controller 26 determines that the RFID is presented, the controller 26 proceeds to procedure 216 in which the alarm system 14 is changed to the deactivated state. If the controller 26 determines that the RFID is not presented, the controller 26 returns to procedure 218, and the alarm continues its output.

The method 200 presents operational procedures performed by the controller 26 in accordance with one embodiment of the present invention. It is contemplated that controller 26 of the alarm system 14 is configured to perform different operational procedures to control the alarm system 14 than those described in the above embodiment.

In the above embodiment (as illustrated in FIG. 9), the use of the RFID tag to activate or deactivate can be replaced by use of a pin-code or password that can be input into the interface 118.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A tool container and alarm system comprising:
a tool container comprising:
a container having a storage space and defining an upwardly facing opening into, the storage space; and
a cover, the cover being movable between a closed position wherein the cover substantially covers the upwardly facing opening and an open position wherein the upwardly facing opening is substantially exposed;
an alarm system generally carried by the container and having an activated state and a deactivated state,
the alarm system, when in the activated state, capable of outputting an alarm indication in response to a condition of the tool container, the alarm system comprising:
a detector configured to detect the condition of the tool container;
a controller configured to receive an input signal from the detector based on the detected condition of the tool container;
a signaling device operatively connected to the controller and configured to generate the alarm indication in response to receiving an output signal from the controller, the output signal from the controller being generated in response to the input signal from the detector; and
a power supply configured for powering the detector and the signaling device.

2. (canceled)

3. The tool container and alarm system of claim 1, wherein the alarm indication of the signaling device is an audio alarm indication.

4. The tool container and alarm system of claim 1, wherein the alarm indication of the signaling device is a visual alarm indication.

5. The tool container and alarm system of claim 1, wherein the detector comprises a motion detector.

6. The tool container and alarm system of claim 5, wherein the motion detector is a tilt detector.

7. The tool container and alarm system of claim 5, wherein the motion detector is an acceleration detector

8. The tool container and alarm system of claim 1, wherein the detector comprises a switch or an opening detector that detects an opening of the cover.

9. The tool container and alarm system of claim 8, wherein the opening detector is a light detector.

10. The tool container and alarm system of claim 8, wherein the switch is an electromechanical switch.

11. The tool container and alarm system of claim 8, wherein the switch is a magnetic switch.

12. The tool container and alarm system of claim 1, wherein the detector comprises, at least two detectors, the at least two detectors comprises a switch or an opening detector that detects an opening of the cover, and a motion detector.

13. (canceled)

14. (canceled)

15. (canceled)

16. (canceled)

17. (canceled)

18. The tool container and alarm system of claim 1, further comprises a lock operatively connected to the controller, the lock is constructed and arranged to lock the cover when the cover is in the closed position.

19. The tool container and alarm system of claim 18, wherein the signaling device and/or the detector is deactivated when the lock is moved to an unlocked condition.

20. The tool container and alarm system of claim 18, wherein the lock comprises an electromagnetic lock.

21. The tool container and alarm system of claim 18, wherein the lock comprises an electrically operated lock.

22. The tool container and alarm system of claim 21, wherein the lock comprises a solenoid.

23. The tool container and alarm system of claim 1, further comprising a wireless device operatively connected to the controller and configured to generate signals to change the alarm system between the activated state and the deactivated state.

24. The tool container and alarm system of claim 23, wherein the controller comprises a receiver wirelessly connected to the wireless device, the receiver is configured to receive the signals from the wireless device.

25. The tool container and alarm system of claim 23, wherein the wireless device is a radio-frequency identification tag or transponder.

26. The tool container and alarm system of claim 23, wherein the wireless device is a hand-held remote transmitter.

27. The tool container and alarm system of claim 26, wherein the transmitter comprises a RF transmitter.

28. The container assembly of claim 24, wherein the receiver comprises a RF receiver.

29. The tool container and alarm system of claim 1, further comprising an user interface panel mounted on the cover, the user interface panel is operatively connected to the controller to change the alarm system between the activated state and deactivated state.

30. (canceled)

31. (canceled)

32. The tool container and alarm system of claim 1, wherein the detector comprises a switch or an opening detector that detects an opening of the cover, and the condition of the tool container comprises the opening of the cover from the closed position.

33. (canceled)

34. (canceled)

35. (canceled)

36. The tool container and alarm system of claim 1, wherein the detector comprises a motion detector, and the condition of the tool container comprises a movement of the tool container detected by the motion detector.

37. (canceled)

38. (canceled)

39. The tool container and alarm system of claim 1, wherein the detector comprises both a switch and a motion detector, and the condition of the tool container comprises an opening of the cover from the closed position and/or a detected movement of the tool container itself.

40. (canceled)

41. (canceled)

42. (canceled)

43. (canceled)

44. (canceled)
